(19) United States
(12) Patent Application Publication
(10) Pub. No.: US 2005/0048898 A1
(43) Pub. Date: Mar. 3, 2005

(54) Clean bench

(76) Inventors: Ta-Kuang Chang, Hsin-Chu (TW); Ya-Tuan Tseng, Hsin-Chu City (TW); Lee-Zen Chen, Hsin-Chu (TW); Bing-Lin Lin, Hsin-Chu City (TW); Li-Chieh Wang, Hsin-Chu (TW); Meil-Li Lee, Yun-Lin (TW)

Correspondence Address: LOWE HAUPTMAN GILMAN & BERNER, LLP, Suite 310, 1700 Diagonal Road, Alexandria, VA, 22314, US

(21) Appl. No.: 10/621,391

(22) Filed: Jul. 18, 2003

(51) Int. Cl. B08B 15/02

(52) U.S. Cl. 454/56

(57) ABSTRACT

A clean bench providing a working space for technicians, in a clean room, to remove and trap particles from the surface of an object with a high-pressure spray gun or a vacuum suction unit. This clean bench has an isolated disposal working space to avoid the escape of particles from it; moreover, it conducts and traps them by the design of a particle-conducting basin and a fan-filter unit (FFU) in it.

### BACKGROUND OF THE INVENTION

1. Field of the Invention

This invention relates to a clean bench, and more particularly to provide a clean bench used in a clean-room environment.

2. Description of the Prior Art

A clean room is commonly used for many production processes where a particle-free environment is essential, or at least highly desirable. Therefore, it is important for technicians to maintain the cleanliness within a clean-room environment. A clean bench used, for example, in the processing apparatuses for the semiconductor industry. Sometimes technicians have to remove particles from the surface of an object with a high-pressure spray gun or a vacuum suction unit within the clean bench. But in the process of cleaning, sprayed particles often flee from a clean bench, causing pollution and lowering the cleanliness of a clean-room environment. An improved clean bench is needed to solve the above problems.

FIG. 1 shows the conventional clean bench 100. The cabinet 101 has a partition wall 103 formed vertically. The partition wall 103 partitions the cabinet 101 into the working space 111 and an airflow passage 105, and does not reach a top wall 107 or a bottom wall 109 of the cabinet 101, thereby enabling the airflow to pass below and above the partition wall 103. The working space 111 is defined by the supporting structure of the partition wall 103 and two side walls of the cabinet 101. In the upper part of the working space 111, a top partition 113 through which airflow can pass freely, e.g. a grate or lattice is provided and a fluorescent lamp 115 is placed under the top partition 113. At the bottom of the working space 111, a bottom partition 117 through which airflow can pass freely is provided and a filter 119 is placed underneath it. The partition wall 103, a rear wall 121 and the two side walls of the cabinet 101 form the airflow passage 105 and a blower 123 is installed below the airflow passage to circulate the circulating airflow. The circulating airflow is circulated by the blower 123 through the airflow passage 105, which is conducted through the top partition 113, which is passed through the working space 111, which is discharged through the bottom partition 117, which is passed through the filter 119 in which particles have been trapped. Finally, the circulating airflow returns to the blower 123 and repeats the above circulation.

The above-mentioned clean bench 101 has an open window, which allows the technician access to the working space 111. Inevitably the airflow has a chance of leaking from the working space 111 with particles, thus forming pollution and lowering the cleanliness of a clean-room environment.

In the above-mentioned clean bench 101, the bottom partition 117 is connected perpendicularly with the partition wall 103 and the two side walls of the cabinet 101. It is easy to form dead spaces and lead the particles collected in them.

### SUMMARY OF THE INVENTION

Therefore, an object of the present invention is to provide a clean bench with an isolated working space for technicians to remove and trap particles from the surface of an object in a clean room.

Another object of the present invention is to provide a clean bench, which can reduce the opportunity for airflow with particles leaking from the working space, thus maintaining cleanliness within a clean-room environment.

The other object of the present invention is to provide a clean bench, which can reduce the dead space of the working space from the particles collected in it.

According to the present invention, there is a clean bench provided with an isolated working space for technicians to remove and trap particles from the surface of an object by using a high-pressure spray gun or a vacuum suction unit in a clean room. The present clean bench comprises a cabinet and a adjustable canopy. A fan-filter unit (FFU), formed by a fan and a filter module, is arranged in the cabinet to circulate an even airflow. The particles produced in the working space will follow the airflow and be trapped in the filter unit. A working space is defined by a particle-conducting basin and an adjustable canopy. At the bottom of the working space, four side walls with a sticky surface and a bottom partition forming the particle-conducting basin. At the upper portion of the working space, the adjustable canopy with a shutter is arranged to control the dimension of the opening access. And a glove port is arranged on the shutter to provide the technician proceeding with clean work with an isolated disposal working space when they sealed the access opening off.

To compare with the conventional clean bench, this invention has at least the following advantages:

(1) A fan-filter unit is arranged in the cabinet to enhance the ability of filtering the particle within a circulating airflow from the working space and to simplify the structure of the conventional clean bench.

(2) The particle-conducting basin is arranged at the bottom of the working space and the sloping design of it's four side walls makes for better conduction of the airflow, lowering the opportunity for particles to be collected in the dead spaces. And with the sticky property, particles will easily stick on the surface of the side walls instead of the conventional situation: colliding with the side walls and then fleeing from the working space, polluting the clean-room environment.

(3) The adjustable canopy with a shutter is arranged to control the dimension of the opening access of the working space. And the glove port is designed to provide the technician proceeding with clean work with an isolated disposal working space when they sealed the access opening off. The sprayed particles of the working space will not escape from the clean bench by the design of the adjustable canopy.

### BRIEF DESCRIPTION OF THE DRAWINGS

The invention will be described further, by way of example, with reference to the accompanying drawings, in which:

FIG. 1 discloses a conventional clean bench;

FIG. 2A illustrates a preferred embodiment of an improved clean bench;

FIG. 2B illustrates a stereogram of a preferred embodiment of an improved clean bench; and

FIG. 3 illustrates another preferred embodiment of an improved clean bench.

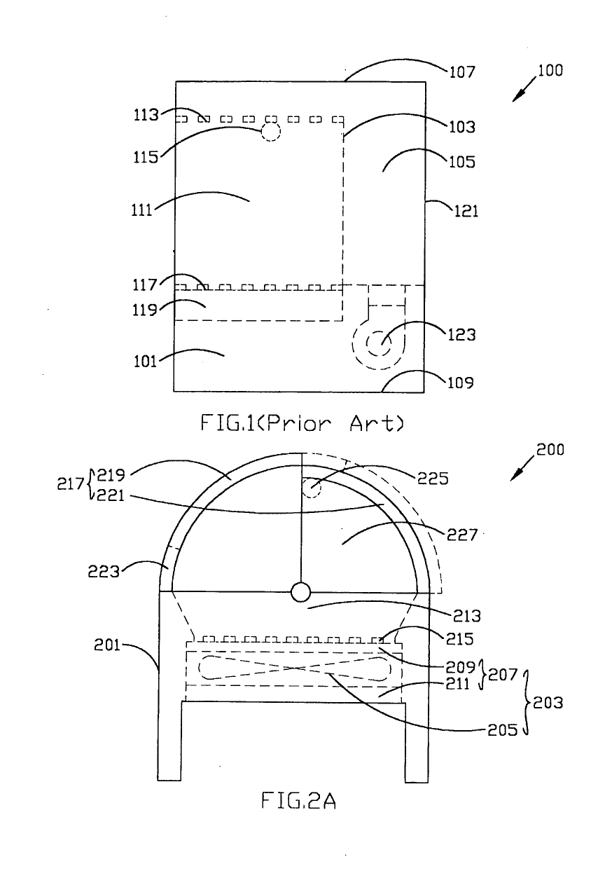

### DESCRIPTION OF THE PREFERRED EMBODIMENT

Some embodiments of the invention are described below. However, except the present details, the invention can also be applied in other embodiments. Hence, the scope of the invention is not limited by the following embodiments, but is decided by the present claims.

The invention presents an improved clean bench with an isolated working space for technicians to remove and trap particles from the surface of an object by using a high-pressure spray gun or a vacuum suction unit in a clean room. The present clean bench comprises a cabinet and a working space. A fan-filter unit (FFU), formed by a fan and a filter module, is arranged in the cabinet to circulate an even airflow, and the particles produced in the working space will follow the airflow and become trapped in the filter module. The working space is enclosed with a particle-conducting basin and an adjustable canopy. At the bottom of the working space, four side walls with a sloping profile and a bottom partition forms the particle-conducting basin. At the upper portion of the working space, the adjustable canopy is arranged to control the dimension of the opening access.

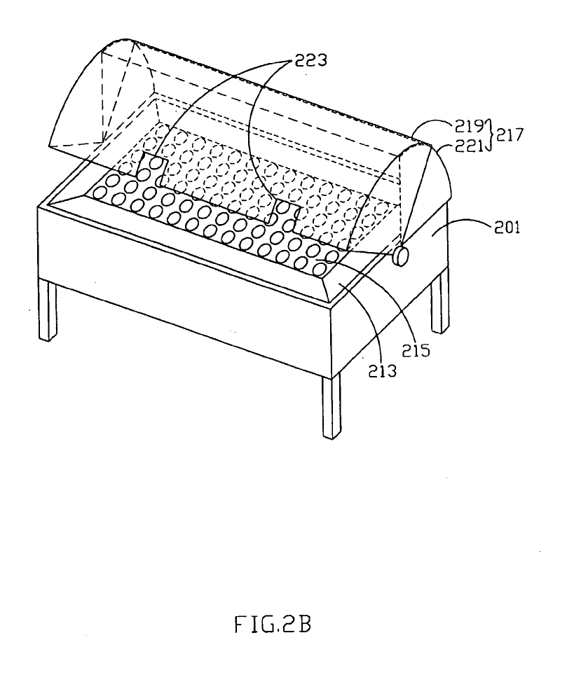

FIG. 2A and FIG. 2B show a preferred embodiment of an improved clean bench 200. The present clean bench 200 is composed of a cabinet 201 and a half-cylindrical adjustable canopy 217. A fan-filter unit (FFU) 203, arranged in the cabinet 201, is composed of a centrifugal fan 205 and a HEPA (High Efficient Particle Air) filter module 207. The centrifugal fan 205 is arranged for drawing an even airflow, and the particles produced in the process of the clean work will follow the airflow and become trapped in the HEPA filter module 207. As for the HEPA filter module 207, a HEPA pre-filter 209 is arranged above the centrifugal fan 205, thus providing a 99.6% reduction in particles as small as 0.3 microns in size. A HEPA filter 211, which provides a 99.97% reduction in particles as small as 0.3 microns in size, is below the centrifugal fan 205. It goes without saying that an ULPA (Ultra Low Penetration Air) filter module (not show), providing 99.9995% reduction in particles as 0.15 microns in size, may be substituted for the filter module 207, depending on the circumstances.

In the upper portion of the cabinet 201, a particle-conducting basin 213 is formed by a bottom partition 215 and four side walls with a sloping profile. The bottom partition 215, through which airflow can pass to the fan-filter unit 203 freely, e.g. a grate or lattice, is provided. And the sloping design of the four side walls makes better conduction of the airflow, lowering the opportunity for particles to be collected in the dead spaces of the particle-conducting basin 213. And by sticking a twin adhesive, particles produced in the process of the clean work will easily become stuck on the surface of the four side walls.

The particle-conducting basin 213 and the half-cylindrical adjustable canopy 217 define A working space 227. Above the particle-conducting basin 213, the half-cylindrical adjustable canopy 217 is composed of a front quarter-cylindrical movable canopy 219 and a back quarter-cylindrical fixed canopy 221. The front quarter-cylindrical movable canopy 219, made of transparent materials, is arranged to control the dimension of the access opening of the working space 227. And a glove port 223 was set on the front quarter-cylindrical movable canopy 219 for the technician proceeding with the clean work when they sealed the access opening off. And by sticking a twin adhesive on the surface toward the working space 227, particles produced in the working space 227 will easily become stuck on the surface of the back quarter-cylindrical fixed canopy 221. A halogen lamp 225 is placed on the upper portion of the working space 227 to provide lighting for the technician proceeding with clean work. The sprayed particles produced in the working space 227 will not easily escape from the clean bench 200, because of the design of above half-cylindrical adjustable canopy 217.

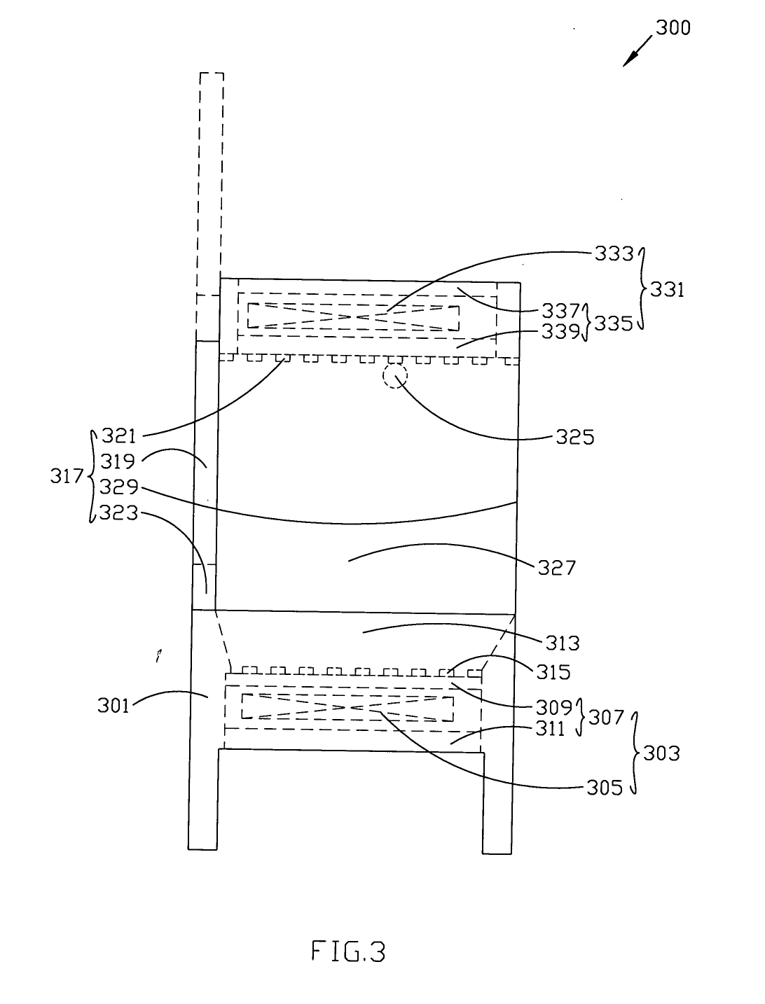

FIG. 3 shows another preferred embodiment of an improved clean bench 300. The present clean bench 300 is composed of a cabinet 301 and a rectangular adjustable canopy 317. A first fan-filter unit (FFU) 303, arranged in the cabinet 301, is composed of a first centrifugal fan 305 and a first HEPA (High Efficient Particle Air) filter module 307. The first centrifugal fan 305 is arranged for drawing an even airflow, and the particles produced in the process of the clean work will follow the airflow and become trapped in the first HEPA filter module 307. As for the first filter module 307, a first HEPA pre-filter 309 providing a 99.6% reduction of particles as small as 0.3 microns in size is arranged above the first centrifugal fan 305, and a first HEPA filter 311 providing a 99.97% reduction of particles as small as 0.3 microns in size is below the first centrifugal fan 305. It goes without saying that an ULPA (Ultra Low Penetration Air) filter module (not show), providing a 99.9995% reduction of particles as small as 0.15 microns in size, may be substituted for the first filter module 307, depending on the circumstances.

In the upper portion of the cabinet 301, a particle-conducting basin 313 is formed by a bottom partition 315 and four side walls with a slopping profile. The bottom partition 315, through which the airflow can pass to the first fan-filter unit 303 freely, e.g. a grate or lattice, is provided. The sloping design of the four side walls makes better conduction of the airflow, lowering the opportunity for particles to be collected in the dead spaces of the particle-conducting basin 313. And by sticking a twin adhesive, particles produced in the process of the clean work will easily become stuck on the surface of the four side walls.

The particle-conducting basin 313 and the rectangular adjustable canopy 317 define a working space 327. Above the particle-conducting basin 313, the rectangular adjustable canopy is enclosed by a top partition 321, a front shutter 319, a rear wall 329 and two side walls. The top partition 321, through which the airflow can pass freely, e.g. a grate or lattice, is provided and a halogen lamp 325 is placed under the top partition 321 to provide lighting for the technician processing with the clean work. The front shutter 319, made of transparent materials, is arranged to control the dimension of the access opening of the working space 327. And a glove port 323 was set on the front shutter 319 for the technician proceeding with the clean work when they sealed the access opening off by the front shutter 321. And a sticky surface is provided on the rear wall 329 and two side walls to collect the sprayed particles produced in the working space 327.

Above the top partition 321 of the rectangular adjustable canopy 317, a second fan-filter unit (FFU) 331 is arranged to draw the airflow from the clean-room environment, thus discharging it into the working space 327. The second fan-filter unit (FFU) 331 is composed of a second centrifugal fan 333 and a second HEPA (High Efficient Particle Air) filter module 335. Particles produced in the clean-room environment will follow the airflow and become trapped in the second HEPA filter module 335. As for the second HEPA filter module 335, a second HEPA pre-filter 337 providing 99.6% reduction of particles as 0.3 microns in size is arranged above the second centrifugal fan 333, and a second HEPA filter 339 providing 99.97% reduction of particles as 0.3 microns in size is below the second centrifugal fan 333. It goes without saying that an ULPA (Ultra Low Penetration Air) filter module (not show), providing a 99.9995% reduction of particles as small as 0.15 microns in size, may be substituted for the second filter module 335, depending on the circumstances.

In the above present invention of an improved clean bench 300, the arrangement of two sets of fan-filter unit (FFU) 303 and 331 is to provide an even circulated airflow through the working space 327, leading the particles trapped into the first HEPA filter modules 307. And the design of the front shutter 319 can prevent the spray particles from escaping the working space 327.

What is said above is only the preferred embodiments of the invention and they are not used to limit the claims of this invention; any changes or modifications that do not depart from the essence displayed by the invention should be limited in what is claimed in the following.

1. A clean bench, comprising:
a cabinet;
a particle-conducting basin arranged in the upper portion of said cabinet, said particle-conducting basin having a bottom partition with plural outlets and four side walls;
an adjustable canopy arranged above said particle-conducting basin, defining a working space with said particle-conducting basin;
a fan arranged under said bottom partition of said cabinet; and
a filter arranged under said bottom partition of said cabinet.

2. The clean bench according to claim 1, wherein said fall is a centrifugal fan.

3. The clean bench according to claim 1, wherein said filter is a HEPA filter.

4. The clean bench according to claim 1, wherein said filter is a ULPA filter.

5. The clean bench according to claim 1, wherein said filter further comprises a HEPA pre-filter.

6. The clean bench according to claim 1, wherein said filter further comprises a ULPA pre-filter.

7. (canceled)

8. The clean bench according to claim 1, wherein said four side walls have a slope profile.

9. The clean bench according to claim 1, wherein said four side walls have a sticky surface toward said working space.

10-11. (cancelled)

12. A clean bench, comprising:
a cabinet;
a particle-conducting basin arranged in the upper portion of said cabinet, said particle-conducting basin having a bottom partition with plural outlets and foul side walls;
a half-cylindrical adjustable canopy arranged above said particle-conducting basin, defining a working space with said particle-conducting basin;
a fan arranged under said bottom partition of said cabinet; and
a filter arranged under said bottom partition of said cabinet, and particles existing in said working space will come through said particle-conducting basin and then be directed into said fan and said filter.

13. The clean bench according to claim 12, wherein said half-cylindrical adjustable canopy comprises a front quarter-cylindrical movable canopy and a back quarter-cylindrical fixed canopy.

14. The clean bench according to claim 13, wherein said front quarter-cylindrical movable canopy comprises a glove port.

15. The clean bench according to claim 13, wherein said front quarter-cylindrical movable canopy is made of a transparent material.

16. The clean bench according to claim 113, wherein said back quarter-cylindrical fixed canopy has a sticky surface toward said working space.

17-39. (cancelled)

40. The clean bench according to claim 12, wherein said fan is a centrifugal fan.

41. The clean bench according to claim 12, wherein said filter is selected from the group consisting of a HEPA filter and a ULPA filter.

42. The clean bench according to claim 41, wherein said filter further comprises a pre-filter, and said pre-filter is selected from the group consisting of a HEPA pre-filter and a ULPA pre-filter.

43. The clean bench according to claim 12, wherein said four side walls are provided with a sloping profile.

44. The clean bench according to claim 43, wherein said four sloping side walls have a sticky surface toward said working space.
